(19) United States
(12) Patent Application Publication
(10) Pub. No.: US 2008/0012687 A1
(43) Pub. Date: Jan. 17, 2008

(54) CONTAINER WITH EMBEDDED RFID TAG

(76) Inventor: Walter M. Rubinstein, Bronx, NY (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/771,264

(22) Filed: Jun. 29, 2007

Related U.S. Application Data
(60) Provisional application No. 60/817,641, filed on Jun. 29, 2006.

(51) Int. Cl. H04B 7/00

(52) U.S. Cl. 340/10.1

(57) ABSTRACT

A container for pharmaceuticals such as pills and tablets has an RFID chip embedded within its wall. The chip preferably transmits and receives at a frequency of approximately 24 GHz. When the container is formed of a thermoplastic, the chip is preferably injected into the soft sidewall of the thermoplastic while it is at an elevated temperature and still in a moldable state. For a glass container, a recess is molded in the wall of the container of an appropriate size to accommodate the chip and after molding the chip is secured within the recess with an adhesive and may be covered to prevent tampering. The memory of the chip stores the nature and quantity of elements stored in the container. By weighing the container after a portion of the contents have been removed, the stored quantity in the chip may be modified.

### CROSS-REFERENCE TO RELATED APPLICATIONS

This application claims priority of U.S. Provisional Patent Application Ser. No. 60/817,641 filed Jun. 29, 2006, which is incorporated herein by reference.

### FIELD OF THE INVENTION

This invention relates to molded containers having RFID chips embedded in their walls and more particularly to a system for forming the containers so as to support the chips and maintain the chip memories with information relating to the contents of the containers.

### BACKGROUND OF THE INVENTION

The U.S. Food and Drug Administration and select drug manufacturers have sponsored an initiative to put RFID chips on the labels of drugs to combat counterfeiting and fraud. Because RFID tags are relatively large, this initiative will only address large drug bottles. The problem of counterfeiting and stolen goods applies even more strongly to small bottles of pharmaceuticals such as expensive injectables, antibiotics, growth hormones, etc. Other expensive bottled goods such as perfumes have long been the victims of counterfeiting.

By use of very high operating frequencies, such as 24 GHz, the size of the antenna required for an RFID chip is minimized sufficiently that the antenna can be formed as an integrated circuit on the chip itself and the resulting device is of very small dimensions.

### SUMMARY OF THE INVENTION

The present invention is accordingly directed toward a bottle or vial or the like, particularly for containing expensive items, such as pharmaceuticals and perfumes, formed with an RFID tag having an integral antenna embedded in its walls, and to a process for embedding such RFID tags and for controlling the memory of such tags to accurately represent the quantity of materials stored in the container.

The present invention preferably employs an RFID tag with an integrated antenna, preferably operating in a high frequency range such as 24 GHz or the like. A 24 GHz chip may be operated with an interrogating circuit spaced a reasonable distance from the container supporting the chip.

Because of the very compact nature of the RFID chip with the integral antenna, the chip may be embedded in containers with relatively thin walls in an unobtrusive manner.

Typically the containers with which the present invention is associated are formed of either glass or thermoplastics. When a glass container is formed, because of the high temperatures associated with molten glass, which might impair the operation of the chip, the RFID chip must be assembled with the container after molding. In order to achieve this, the glass container is formed with an indentation in the outer surface of its sidewall, of a configuration suitable for retaining the chip. After molding and cooling of the container, a coating of adhesive is preferably formed on the surface of the indentation and the chip is inserted and adhered within the indentation. A cover plate, preferably of the same material as the body, may be formed over the exposed surface of the chip with integrated antenna, supported in the recess in the bottle.

In the case of a bottle formed of a thermoplastic, the chip and its antenna, which can typically experience temperatures in the range of 400° F. without degradation, are preferably injected into the sidewall while the plastic is still at an elevated temperature, typically below 300° F., which is required by the molding process. The RFID chip becomes embedded in the wall and covered on its outer surface so that no later adhesion or covering is required.

The RFID chip incorporates a memory which may be interrogated by an exterior responder. When the package is filled, the memory is preferably encoded to store the nature and quantity of the materials in the container, the date of bottling, and other pertinent information. When quantities are removed from the container, the container may be weighed and a signal sent to the memory indicating the remaining quantity and the date of removal of particular quantities.

### BRIEF DESCRIPTION OF THE DRAWINGS

Other objects, advantages and applications of the present invention will be made apparent by the following detailed description of several preferred embodiments of the invention. The description makes reference to the accompanying drawings in which:

FIG. 1 is a view of one side of an RFID chip useful with the present invention illustrating an antenna formed on the back side of the chip;

FIG. 2 is a front view of an alternative form of an RFID chip with integrated antenna illustrating its parts in schematic form;

FIG. 3 is a side view of the chip of FIG. 1;

FIG. 4 is an illustration of a container formed in accordance with the present invention containing an embedded RFID chip with an integral antenna;

FIG. 5 is an illustration of a glass container with a recess molded in its outer sidewall for reception of an RFID chip; and

FIG. 6 illustrates a pharmacy inventory control system in which the weight of the container is used to modify the contents of the memory with regard to the quantity stored within the container.

### DETAILED DESCRIPTION OF A PREFERRED EMBODIMENT OF THE INVENTION

The RFID chip with an integral antenna preferably operates in the gigahertz range, preferably above about 20 GHz, and most preferably at 24 GHz. This is in the microwave range and requires a specialized thin film material of very high insulation value for use with microwave frequencies. Typical materials include aluminum oxide, beryllium oxide, aluminum nitride, fused silica quartz and sapphire.

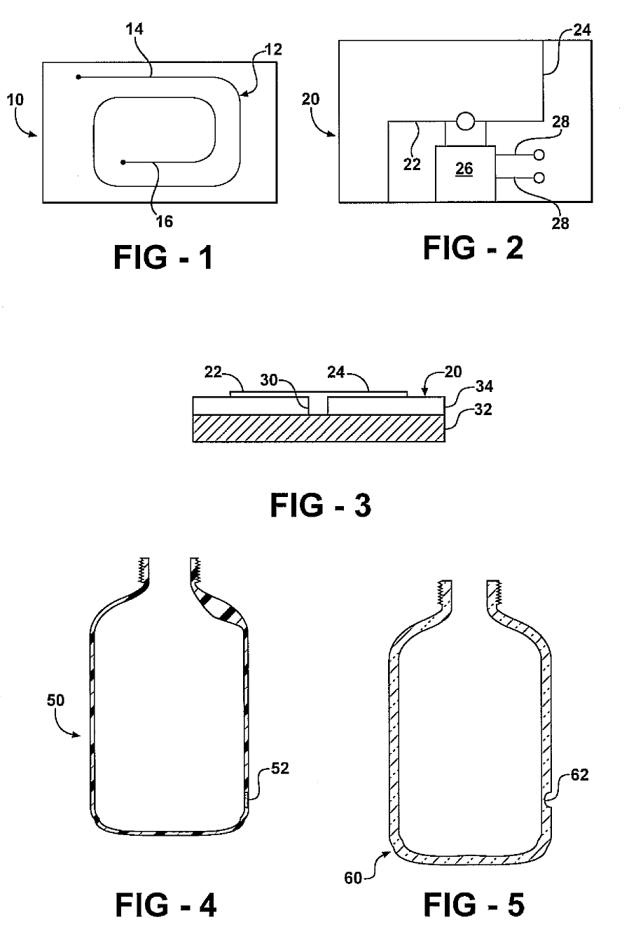

FIG. 1 illustrates an RFID chip 10 which has an antenna 12 formed on its back side either through sputtering or conventional lithographic techniques. The antenna 12 takes the form of a coil having two ends 14 and 16 which terminate at through-hole connections joined to a conventional RFID chip formed by thin film techniques on the opposite side of the substrate 10. The thin film circuitry preferably includes a microwave to UHF translator disposed between the antenna and the chip transponder itself to convert the microwave frequencies into the UHF frequencies required by the chip and to convert the signals generated by the chip into microwave frequencies for outward transmission via the antenna 12.

FIG. 2 illustrates an alternative form of RFID chip with integral antenna. The device is formed on a suitable substrate 20 and includes two conductors 22 and 24, preferably formed by lithography, forming a microwave antenna. The terminals of the microwave antenna connect to a UHF/microwave translator 26 which has two output terminals 28 which pass through through-holes 30 in the substrate 20 to connect to RFID circuitry integrally formed on the opposite side of the substrate 20.

FIG. 3 illustrates a side view of the chip of FIG. 2 with the RFID circuitry 32 integrally formed on one side and an insulating layer 34 supporting the antenna and the translator on the opposite side of the chip.

FIG. 4 illustrates a container 50 formed of a thermoplastic material containing an RFID chip 52 embedded within its walls. The RFID chip is injected during the production of the container 50 while the plastic is in a softened state; the molding process may be blow molding, vacuum forming or the like.

FIG. 5 illustrates a cross-section through a container 60 formed of glass and molded with a recess 62 formed in the outer side of one of its sidewalls. The recess 62 is formed during the molding of the bottle and is of suitable dimensions to receive the RFID chip with integrated antenna of the present invention. An adhesive such as an epoxy may be coated on the sides of the recess before insertion of the chip and a cover plate of the glass material or other suitable material may be formed over the exposed surface of the chip as it sits in the recess.

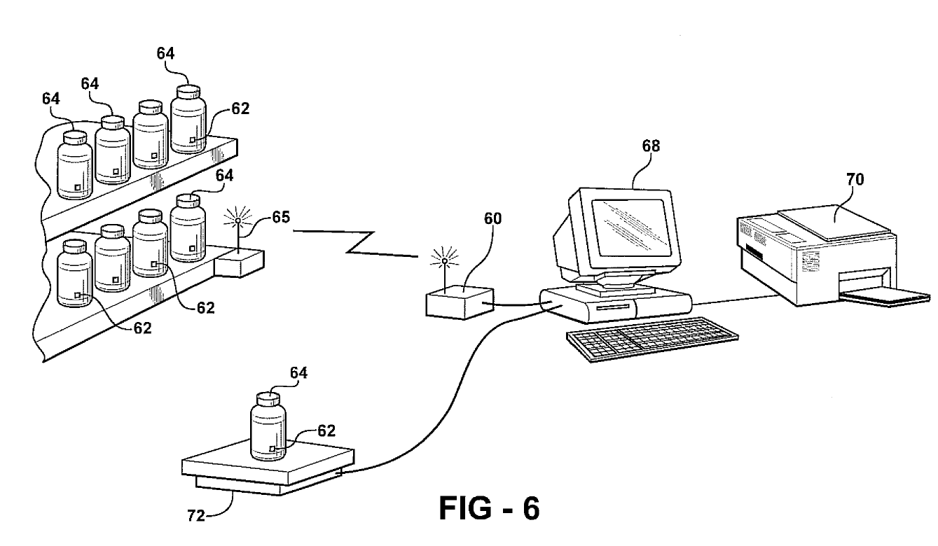

FIG. 6 illustrates the present invention used in a pharmacy control system. The system employs an RFID reader 60 which is capable of reading an RFID chip with integral antenna 62 formed within a container 64. The antenna 65 of the reader may be placed on a shelf 66 of a pharmacy. The reader 60 is connected to a computer 68 which controls a printer 70.

The inventory system is formed as an application program within the computer constantly receives data from all the bottles 64 disposed on the shelf 66. The name of each product, its quantity and other information is constantly updated within the computer 68.

When a pharmacist removes a bottle 64 from the shelf 66 to fill a prescription, the computer notes the removal of that container from the shelf. After the pharmacist removes the prescribed quantity from the bottle, he places it on a platform 72 which weighs the container and its contents and sends a signal to the computer 68 denoting the new weight. The computer decrements its memory with respect to the quantity of remaining pills in the container.

Having thus described my invention I claim:

1. A molded container having an RFID chip with an integral antenna disposed within the sidewalls of the chip, the RFID chip having an operating frequency in excess of 2 GHz.

2. The container of claim 1 formed of glass wherein the RFID chip is disposed in a recess formed in the outer surface of the sidewall of the glass container during molding of the container by an adhesive coating.

3. The container of claim 2 including a cover element overlying the exposed side of the RFID chip.

4. The container of claim 1 formed of a thermoplastic wherein the RFID chip with an integral antenna is embedded within the sidewall of the container while it is in a plastic state during formation of the container.

5. The system of claim 1 wherein the RFID chip comprises a microwave to UHF translator disposed between the antenna and the RFID chip.

6. The container of claim 1 wherein the RFID chip has the antenna formed on one surface, an integrated RFID circuit formed on the opposed surface, and through holes allowing circuitry connections between the antenna and the RFID chip.

7. The container of claim 1 wherein the RFID chip comprises a memory relating to the nature of the contents and including means for modifying the memory as part of the contents are removed from the container.
